(19) United States
(12) Patent Application Publication
(10) Pub. No.: US 2004/0247749 A1
(43) Pub. Date: Dec. 9, 2004

(54) Sealed single serve containers for wine

(75) Inventors: Michael L. Lambert, Eugene, OR (US); Lori Evans Bartman, Sylvania, OH (US)

Correspondence Address: FITCH EVEN TABIN AND FLANNERY, 120 SOUTH LA SALLE STREET, SUITE 1600, CHICAGO, IL, 60603-3406, US

(73) Assignee: Snapdragon

(21) Appl. No.: 10/454,026

(22) Filed: Jun. 4, 2003

(51) Int. Cl. A23B 4/00

(52) U.S. Cl. 426/107

(57) ABSTRACT

The present invention is directed to a sealed packaged wine product in a single serve container. The packaged wine product includes an oxygen barrier container, a volume of wine disposed within the oxygen barrier container, and a volume of one or more gases within the oxygen barrier container.

### FIELD

This invention relates to the packaging of wine. More particularly this invention relates to a packaged wine product in sealed single serve containers, which can be closed after opening and from which the wine can be consumed after opening.

### BACKGROUND

Consumers associate quality with the traditional packaging of the cork-sealed 750 ml bottle and do not want to purchase premium wine in totally non-traditional packages. Nevertheless, there are major problems with this traditional packaging of wine. The cork taints or spoils an estimated 3% to 5% of all premium wine. Wine bottles are breakable, are very heavy and are hard to handle, especially in the standard case of 12 bottles, which weighs about 35 lbs. This weight problem contributes to workplace injuries and high shipping costs. Each bottle holds too big a volume (four glasses) for many occasions, it is hard to reseal and hard to store after it is opened. Because the 750 ml bottle is large, it is often not consumed at one sitting and the wine spoils if it is not consumed within a few days.

Consumers, especially the handicapped and the elderly, encounter difficulty extracting the cork. Removing the cork requires a special implement, which must be purchased separately. Consumers also associate the enjoyment of premium wine with the use of stemmed wine glasses. A stemmed wine glass allows one to hold the glass without imparting heat to the wine. It also is designed to maximize the enjoyment of the aroma and bouquet of the wine, allowing the consumer to swirl the wine in the glass and to concentrate the volatile components as they come in contact with the olfactory organ where the glass narrows at its opening. But stemmed wine glasses are not always available when the consumer might wish to enjoy a glass of wine. Most wine glasses are also breakable and therefore not appropriate for use around swimming pools, at sports stadiums and many other situations.

There is a need both among consumers and brand owners to provide wine in a package that the consumer still perceives as within the tradition of premium wine but which nevertheless overcomes the problems of cork taint, bottle breakage, injuries and high shipping costs due to excessive weight, spoilage of wine due to excessive volume per container, the requirement for the purchase of a corkscrew, the difficulty of removing a cork, the need for purchasing wine glasses to properly serve and enjoy the wine and the problems associated with the breakage of wine glasses.

### SUMMARY

The invention is directed to a sealed packaged wine product in a single serve container from which the wine can be consumed after opening and a method for packaging wine. The sealed container includes a wine filled receptacle, which has a general truncated “tear drop” design. In a very important aspect, the receptacle is on a stem, which is connected to a base which receptacle/stem/base and which combination forms a plastic stemware container for a single serving of wine.

The top of the receptacle has a rim. The rim may include a top surface and a side surface, which extends downward from the top surface. In one aspect, the side surface of the rim includes a frustoconical portion and an undercut closure retaining surface below the frustoconical portion. The closure also includes a removable film seal peelably sealed and removable from the top surface of the rim. After removal of the film seal, no residue is left on the rim that perceptibly impacts visual, tactile or organoleptic properties of the rim or the wine when wine is sipped from the receptacle over the rim to which the film was sealed. The closure also includes a reclosable overcap which snapingly engages the rim. The overcap comprises a top wall and a side wall extending therefrom. The side wall has an interior rib defining a reduced inner diameter for interacting with the rim such as, the frustoconical portion of the side surface of the rim to removably and snapably retain the closure on the receptacle.

The stemware container when filled with wine has a center of gravity which is slightly above one half the height of the container, but no higher than about 0.6 to about 0.65 the height of the container to avoid the filled container having a tendency to tip. Due to the very delicate nature of wine and due to the rapid deleterious effect that air and/or oxygen has on wine, the container should minimize the perviousness to oxygen of the receptacle containing the wine. In this connection in an important aspect, the receptacle portion of the container is blow molded polyethylene terephthalate (PET). Blow molding the PET apparently orients the polymer molecules such that not only does the PET provide a clear glass-like container which is strong, tough and flexible, but also minimizes air and oxygen going though the container to adversely affect the wine. In this aspect of the invention, the blow molding of the PET provides an oxygen barrier that is about 25% to about 50% better than a PET barrier where the polymers have not been oriented by blow molding.

In another aspect the container has a reinforced stem which not only enhances the strength of the container to make it a stronger package to endure the rigors of shipping, but the reinforced stem also makes manufacturing easier. In this connection the stemware container includes a one-piece, unitary, integral blow molded receptacle structure which has a lower truncated spherical base portion which is effective for holding most of the wine in the stemware container and an upper stem portion extending downward from the spherical portion. The upper stem portion is mechanically interfitted and fixed via welding or an adhesive to a lower stem portion extending upward from the base to form the reinforced stem. The reinforced stem is short to keep it strong, but it is sufficiently flexible so that it can slightly bend, but not break during shipping or stacking on store shelves. The length of the reinforced stem generally approximates the width of one or two human fingers so that the glass may be held by the stem and not the base of the receptacle. Generally, the reinforced stem has a length from about one half inch to about one and one quarter inch. Preferably the upper stem portion is mechanically inter-fitted with and sonically welded to the lower stem portion to form a reinforced stem. The base with its upwardly extending stem may be separately injection molded or blow molded.

In yet another aspect, the receptacle includes an upwardly extending frustoconical portion which extends upwardly from the spherical portion to the rim. The frustoconical portion defines a headspace above the wine. The headspace has a diameter at the surface of the wine about equal to or only slightly larger than at the upper portion of the frustoconical portion at the rim of the container. The design of the headspace is such that it will minimize the exposure to the wine to any gas above the level of the wine, but permit the consumer to experience the aroma of the wine as part of a consuming experience when the container is opened. The headspace generally dosed with a gas which is less deleterious to wine than is air or oxygen. Such gases include nitrogen, carbon dioxide and argon. Nitrogen is a more preferred gas with carbon dioxide being less preferred.

In another aspect, the present invention provides a method for packaging a wine product that is effective for minimizing adverse effects of oxygen on wine. The method provides a single serving wine package that is a glass-like stemware container, but which is tough and flexible. In accordance with the method, a predetermined volume of wine is added to an oxygen barrier container. A substantially oxygen free atmosphere is maintained in the container by adding a predetermined volume of one or more gases. The container is sealed with a removable film seal effective for minimizing or eliminating air or oxygen from entering the container. A snapable reclosable overcap may be placed over the removable film seal.

### BRIEF DESCRIPTION OF THE FIGURES

FIG. 1 is a side view of the container.

FIG. 2 is a side view of the receptacle portion of the container.

FIG. 3 is a side view of the base portion of the container.

FIG. 4 is a side view showing the rim of the container engaged with the reclosable overcap.

FIG. 5 is a side view of the container with its reclosable overcap removed.

FIG. 6 is a side view of the container illustrating its center of gravity.

### DETAILED DESCRIPTION

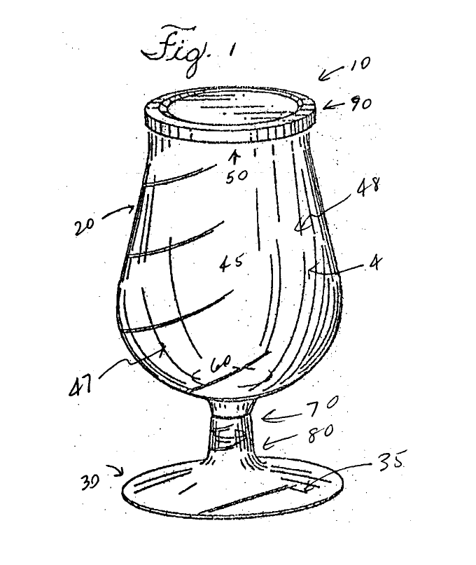

As shown in FIG. 1, the oxygen barrier container 10 includes a receptacle 20 supported on a base 30, and a closure 90. The base 30 includes a broad lower portion 35 and a lower stem portion 80 extending upward from the broad lower portion 35. Generally, the lower portion is circular.

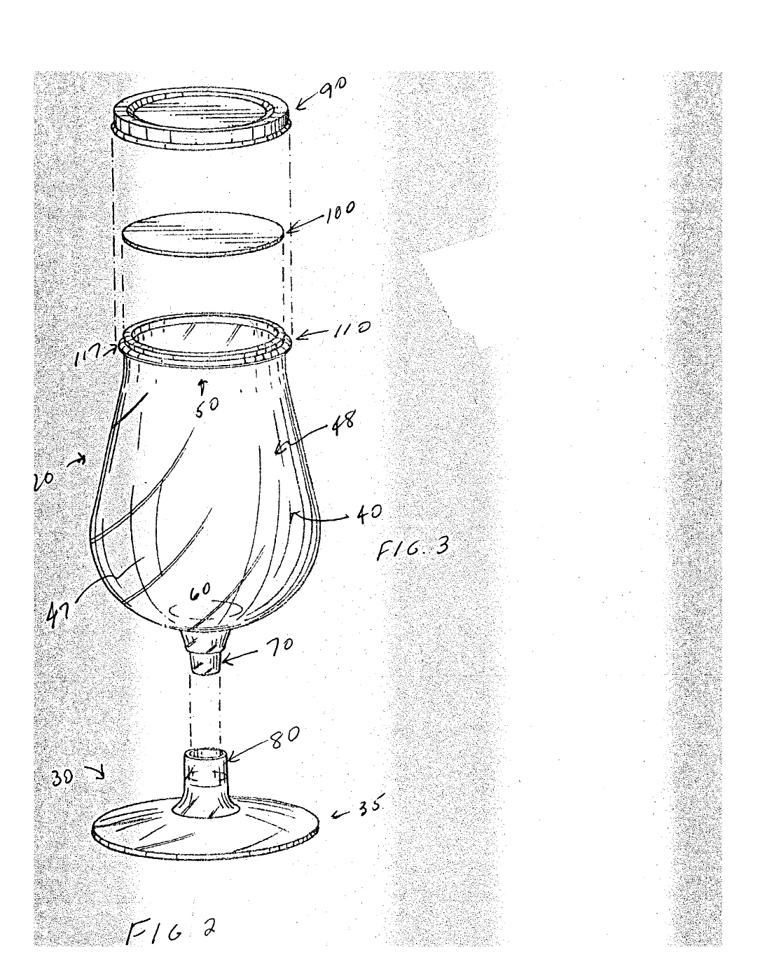

As shown in FIG. 1 and further shown in FIG. 2, the receptacle 20 may be a one-piece, unitary, integral blow molded structure that includes a wall 40 that defines an interior 45. The receptacle includes a lower truncated spherical portion 47 that is effective for holding most of the wine and a frustoconical portion 48 extending towards a rim 110. An upper stem portion 70 extends downward from the wall 40. The upper stem portion 70 may be mechanically inter-fitted and welded to the lower stem portion 80 to form a reinforced stem. The receptacle 20 generally will hold about 187 ml of wine and the frustoconical portion 48 of the receptacle 20 will define a volume of about 11 cubic centimeters of headspace. Moreover, the headspace at the surface of the wine at 20 generally will define an area at the surface of the wine which is about equal to or only slightly larger than the area defined by the circumference at the rim 110 to minimize the contact of the wine with the gases in the headspace. The headspace should not be more than about 8% of the volume of the receptacle and is preferably less.

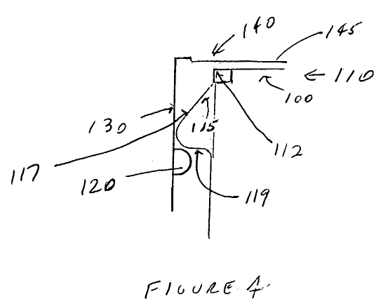

FIG. 3 further illustrates the base 30 of the oxygen barrier container 10. The base may be formed by injection molding as single piece to include a broad circular lower portion 35 and a lower stem portion 80.

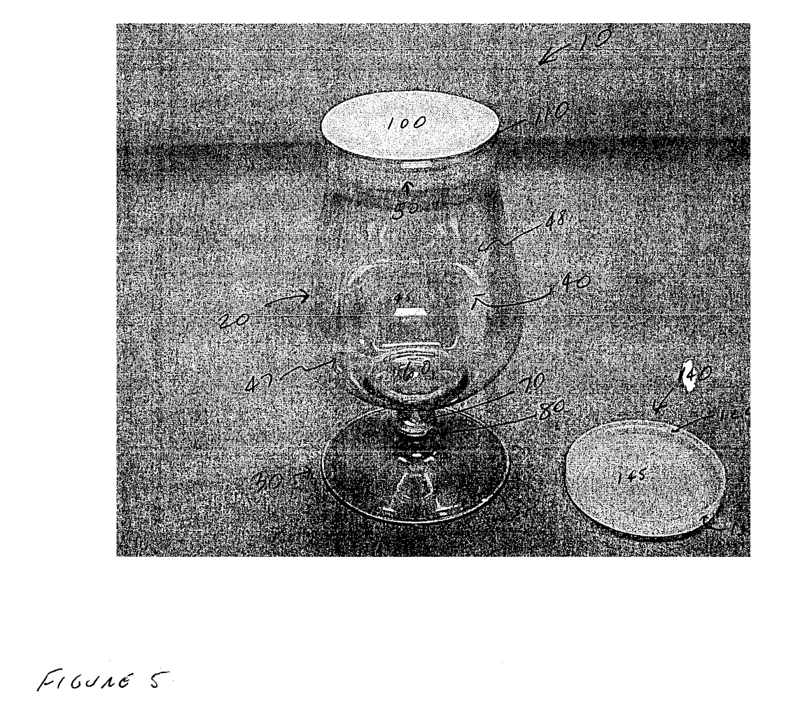

The receptacle 20 includes a bottom portion 60 with wall 40 of the receptacle 20 ending in a rim 110 that defines an open upper end 50. As shown in FIG. 4, the rim 110 includes a top surface 112 and a side surface 115 extending down from the top surface 112. The side surface 112 includes a frustoconical portion 117 and an undercut closure retaining surface 119.

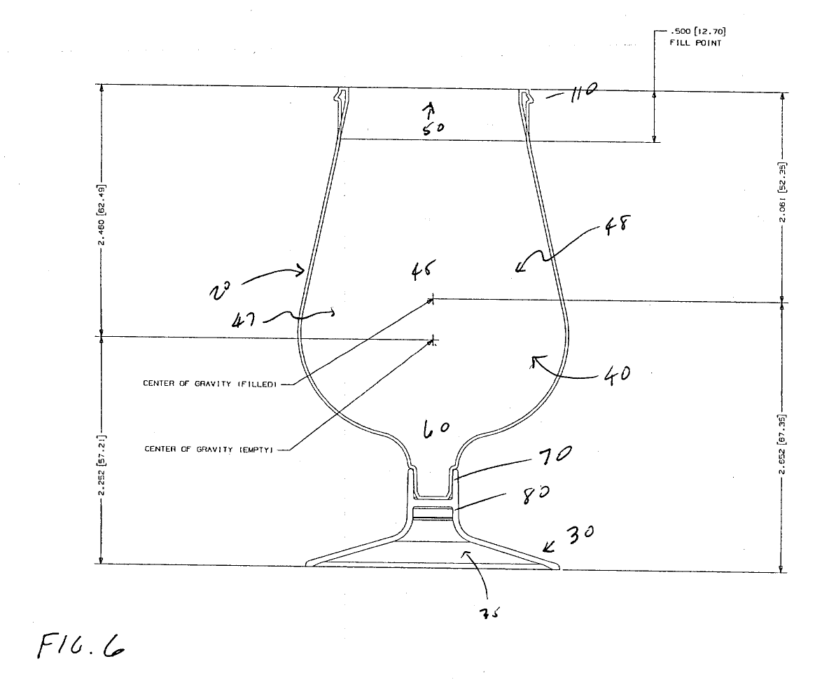

As further shown in FIG. 1 and further shown in FIG. 5, the closure 90 includes a removable film seal 100 peelably sealed to the top surface 112 of the rim 110. The closure 90 also includes a snapable reclosable overcap 140. The reclosable overcap 140 includes a top wall 145 with a sidewall 130 extending downward from the top wall 145. The sidewall 130 includes an interior rib 120 that defines a reduced inner diameter for interacting with the frustoconical portion 117 of the side surface 115 of the rim 110.

FIG. 6 shows the location of the center of gravity for both an empty and filled container. For the empty container, the center of gravity is slightly below the midpoint of the container. For the filled container, the center of gravity is slightly above the midpoint of the container.

Production of Containers

The containers of the present invention may be made of any suitable blow moldable thermoplastic resin. Examples of suitable resins include polyesters (including polyethylene terephthalate), polyethylene, high density polyethylene, polypropylene, polycarbonate, polystyrene, polyvinyl chloride, and acrylonitrile. In an important aspect, the container and most particularly the receptacle 20 is blow molded polyethylene terephthalate where the blow molding orients the polymer molecules to enhance the ability of the receptacle 20 to exclude oxygen. Advantageously, the blow molded PET provides a clear glass-like container.

The receptacle 20 portion of the oxygen barrier container 10 is made using a one-step injection stretch blow molding process. The process starts by feeding raw resin pellets through a dehumidifying dryer to remove moisture absorbed by the atmosphere. The dried pellets may then be fed into a heated barrel where they are compressed and melted by a rotating screw. The melted resin is then injected into an injection mold that is cooled with chilled water. The resin is cooled slightly, but rapidly, by the cold mold which hardens the resin into a preform.

Hot preforms are indexed to a conditioning station where they may be adjusted. Preforms are placed between two open blow mold halves and the mold is closed. A stretch rod is used to stretch the preform to the length of the blow mold while simultaneously introducing high pressure air to blow the preform like a balloon. When hot resin touches the inside of the chilled blow mold, it cools and becomes rigid. The blowing and stretching is effective for biaxial orientation to the resins which improves strength and oxygen barrier properties as compared to unstretched material.

The base 30 of the container 10 may be injection molded. The receptacle portion 20 and base portion 30 may be joined by known methods such as ultrasonic welding or solvent welding.

Filing and Sealing of Containers

The oxygen barrier container 10 is filled with wine and packaged in a continuous operation of filing and sealing by known methods which may include sparging of the container with small amounts of liquid nitrogen before and/or after filling and by filling in an oxygen free environment. In an important aspect, the oxygen barrier container 10 is filled in a way and in an amount effective for minimizing the surface area of the wine to any gas in the headspace of the container. Providing a volume of 187 ml of wine is effective for minimizing the surface area of the wine.

After filling, the oxygen barrier container 10 is sealed with a closure 90 that includes a removable film seal 100 peelably sealed and removable from the top surface 112 of the rim 110. The removable film seal 100 may be made of material which acts as a barrier to oxygen. Examples of the materials that can be used for the removable film seal 100 include a heat sealable foil laminates produced by packaging suppliers, such as Selig and Unipac. Sealing of the removable film seal 100 may be done using a known method such as induction sealing which may be done by companies such as, Enercon Industries Corporation (Menomonee Falls, Wis.).

Induction sealing is a non-contact heating process that accomplishes the sealing of a container with a closure that may include a heat sealable foil laminate inside of the closure. The closure may include a layer of pulpboard or foam, a layer of wax, aluminum foil and a layer of heat activated polymer that is compatible with the container material. This type of innerseal which leaves a pulpboard or foam liner inside of the cap is commonly referred to as a 2-piece innerseal.

In another aspect, sealing may be accomplished with a single piece innerseal which functions the same as the two-piece innerseal, but as its name suggests, nothing is left inside of the cap. There are various combinations of innerseal materials, some are foam backed and some paper backed. They may also be custom printed with a customer's logo or trademark, or can contain some type of generic message, such as “sealed for freshness.” They may be very aggressive (welded) and have to be destroyed to be removed or they may be peelable for easy removal.

The standard induction sealer has two main components: the power supply and the sealing head. The power supply is an electrical generator capable of operating at the medium to high frequencies required for the induction sealing process. It supplies the induction sealing head with the current necessary to create the electromagnetic field. The power supply rating required for a specific application will depend upon the size of the closures and the speed of the production line.

The sealing head consists of a plastic housing with a conductor wound to form an inductive coil inside. The head produces an electromagnetic field when energized by the power supply. The most common shapes used in induction sealing are the flat head and the tunnel head. A tunnel head concentrates the current around the sides and above the cap creating a more uniform electromagnetic field and a more consistent seal. A flat head disperses the magnetic field more widely allowing a larger area (and larger cap) to be sealed.

There is a third possible component to the induction sealer which is a water recirculator. The water recirculator is a water-to-air heat exchanger which cools the sealing head by pumping water through the sealing head coil via leads connecting the two.

The sealing process takes place after the filling and capping operation. The capped containers simply pass underneath the induction sealing unit which is mounted on the conveyor. As they do so, they pass through the electromagnetic field created by the induction heater. An electromagnetic current called an eddy current is inducted into the foil resulting in a resistance-type heating effect.

Numerous modifications and variations in practice of the invention are expected to occur to those skilled in the art upon consideration of the foregoing detailed description of the invention. Moreover, it should be recognized that the configurations of the container should advantageously be made in an ascetically pleasing way. Consequently, such modifications and variations are intended to be included within the scope of the following claims.

What is claimed is:

1. A packaged wine product comprising:
an oxygen barrier container;
a volume of wine disposed within said oxygen barrier container; and
a volume of one or more gases contained within said oxygen barrier container, the gases having less of a deleterious effect on the wine than air, the oxygen barrier container comprising:
a base;
a receptacle supported on the base; and
a closure,
the base comprising a lower stem portion extending upward therefrom,
the receptacle being a one-piece, unitary, integral blow molded structure comprising a wall defining an interior containing the volume of wine and an upper stem portion extending downward from the wall, the upper stem portion fixed via welding or adhesive with the lower stem portion to form a reinforced stem,
the wall having a rim defining an open upper end,
the rim including a top sealing surface, and
the closure comprising a removable film seal peelably sealed to the top surface of the rim and removable therefrom wherein the film seal also provides an oxygen barrier.

2. The package wine product of claim 1, wherein the closure further comprising a snapable overcap comprising a top wall and a side wall extending therefrom.

3. The package wine product of claim 1, wherein the base includes a broad circular lower portion.

4. The package wine product of claim 1, wherein the upper stem portion is mechanically interfitted with and welded to the lower stem.

5. The package wine product of claim 1, wherein a headspace of the container is not more than about 8% of the total volume.

6. A stemware packaged wine product comprising:
a stemware container;
a volume of wine disposed within the stemware container; and
a volume of one or more gases contained within the stemware container, the stemware container comprising:
a base;
a blow molded polyethylene terephthalate receptacle supported on the base; and a closure,
the base comprising a broad circular lower portion having a predetermined diameter and a lower stem portion extending upward therefrom,
the receptacle being a one-piece, unitary, integral blow molded structure comprising a wall defining an interior containing the predetermined volume of wine and an upper stem portion extending downward from the wall, the upper stem portion being fixed via welding or adhesive with the lower stem portion to form a reinforced stem,
the wall having a rim defining an open upper end,
the receptacle having a diameter that varies over its height with a maximum diameter of the receptacle being at a point closer to the bottom than to the top of said container such that the center of gravity of the stemware container is below one half of the total height of the container,
the rim including a top surface and a side surface extending downward therefrom,
the closure comprising a removable film seal peelably sealed to the top surface of the rim and removable therefrom without leaving a residue that perceptibly impacts visual, tactile or organoleptic properties of the rim or the volume of wine when wine is sipped from the receptacle over said rim, and
the closure further comprising a reclosable overcap which snapingly engages the rim, the overcap comprising a top wall and a side wall extending therefrom.

7. The packaged wine produce of claim 6, wherein a headspace is filled with a gas which has a deleterious effect on the wine in the container which is less than air.

8. The packaged wine product of claim 7, wherein the gas is selected from the gorup consisting of nitrogen, carbon dioxide, argon and mixtures thereof.

9. The packaged wine product as recited in claim 6, wherein the reinforced stem has a length from about one half inch to about one and one quarter inch.

10. The packaged wine product as recited in claim 6, wherein the volume of the wine in the container is about 187 ml.

11. A stemware packaged wine product comprising:
a stemware container;
a volume of wine disposed within the stemware container; and
a volume of one or more gases contained within the stemware container, the stemware container comprising:
a base;
a blow molded polyethylene terephthalate receptacle supported on the base; and a closure,
the base comprising a lower stem portion extending upward therefrom,
the receptacle being a one-piece, unitary, integral blow molded structure comprising a wall defining an interior containing the predetermined volume of wine and an upper stem portion extending downward from the wall, the upper stem portion being fixed via welding or adhesive with the lower stem portion to form a reinforced stem,
the wall having a rim defining an open upper end,
the receptacle having a diameter that varies over its height with a maximum diameter of the receptacle being at a point closer to the bottom than to the top of said container such that the center of gravity of the stemware container is below one half of the total height of the container,
the rim including a top surface and a side surface extending downward therefrom,
the side surface of the rim including a frustoconical portion and an undercut closure retaining surface therebelow, and
the closure further comprising a removable seal peelably sealed to the top surface of the rim and removable therefrom without leaving a resicue that perceptibly impacats visual, tactile or organoleptic properties of the rim or the volume of wine when wine is sipped from the receptacle over said rim.

12. The stemware packaged wine product of claim 11, wherein the closure further comprising a snapable overcap comprising a top wall and a side wall extending therefrom.

13. The stemware packaged wine product as recited in claim 11, wherein the blow molded polyethylene terephthalate receptacle supported on the base comprises:
a lower truncated spherical base portion which is effective for holding most of the wine in the stemware container; and
a frustoconical portion,
the spherical base portion being above the upper stem and below the frustoconical portion which frustoconical portion extends upwardly from the spherical portion to the rim,
the frustoconical portion defining a headspace above the wine, the headspace having a diameter which is equal to or larger at surface of the wine than an upper portion below the rim.

14. The stemware wine product as recited in claim 13, wherein a headspace is filled with a gas which has a deleterious effect on the wine in the container which is less than air.

15. The stemware wine product of claim 14, wherein the gas is selected from the group consisting of nitrogen, carbon dioxide, argon and mixtures thereof.

16. The stemware wine product as recited in claim 13, wherein the reinforced stem has a length from about one half inch to about one and one quarter inch.

17. The stemware wine product as recited in claim 16, wherein the volume of the wine in the container is about 187 ml.

18. A method for packaging a wine product comprising:
adding a volume of wine to an oxygen barrier container;
adding a volume of one or more gases; and
sealing the oxygen barrier container with a removable film seal,
the oxygen barrier container comprising a receptacle comprising blow molded polyethylene terephthalate.

19. The method of claim 18, wherein the method further comprises placing a snapble overcap over the removable film.

20. The method of claim 18, wherein a headspace is filled with a gas which has a deleterious effect on the wine in the container which is less than air.

21. The method of claim 20, wherein the gas is selected from the group consisting of nitrogen, carbon dioxide, argon and mixtures thereof.

22. The method of claim 21, wherein the volume of the wine in the container is about 187 ml.

23. A method for packaging a wine product comprising:
adding a volume of wine to a stemware container;
adding a volume of one or more gases;
sealing the stemware container with a removable film seal, and
placing a snapable reclosable overcap over the removable film seal,
the stemware container comprising:
a base;
a blow molded polyethylene terephthalate receptacle supported on the base; and a closure,
the base comprising a lower stem portion extending upward therefrom,
the receptacle being a one-piece, unitary, integral blow molded structure comprising a wall defining an interior containing the volume of wine and an upper stem portion extending downward from said wall, the upper stem portion being fixed via welding or adhesive with the lower stem portion to form a reinforced stem,
the wall having a rim defining an open upper end,
the receptacle having a diameter that varies over its height with a maximum diameter of the receptacle being at a point closer to the bottom than to the top of said container such that the center of gravity is below 0.65, the total height of the container when the container is filled with wine,
the rim including a top surface and a side surface extending downward therefrom,
the closure comprising a removable film seal peelably sealed to said top surface of the rim and removable therefrom without leaving a residue that perceptibly impacts visual, tactile or organoleptic properties of the rim or the predetermined volume of wine when wine is sipped from the receptacle over said rim.

24. The method of claim 23, wherein a headspace is filled with a gas which has a deleterious effect on the wine in the container which is less than air.

25. The method of claim 24, wherein the gas is selected from the group consisting of nitrogen, carbon dioxide, argon and mixtures thereof.

26. The method of claim 23, wherein the reinforced stem has a length from about one half inch to about one and one quarter inch.

27. The method of claim 23, wherein the volume of the wine in the container is about 187 ml.

28. A packaged wine product comprising:
a container;
a volume of wine disposed within the container; and
one or more gases contained within the container, the gases having less of a deleterious effect on the wine than air, the container comprising:
a blow molded polyethylene terephthalate receptacle and a closure,
the receptacle being a one-piece, unitary, integral blow molded structure comprising a wall defining an interior containing the volume of wine,
the wall having a rim defining an open upper end,
the receptacle having a diameter that varies over its height with a maximum diameter of the receptacle being at a point closer to the bottom than to the top of the container,
the rim including a top surface and a side surface extending downward therefrom,
the side surface of the rim including a frustoconical portion and an undercut closure retaining surface therebelow,
the closure comprising a removable film seal peelably sealed to the top surface of the rim and removable therefrom without leaving a residue that perceptibly impacts visual, tactile or organoleptic properties of the rim or the predetermined volume of wine when wine is sipped from the receptacle over said rim,
the closure further comprising a reclosable overcap comprising a top wall and a side wall extending therefrom, the side wall having an interior rib defining a reduced inner diameter for interacting with said frustoconical portion of said side surface of the rim to removable retain said closure on said receptacle.

29. The packaged wine product of claim 28, wherein the gas is selected from the group of nitrogen, carbon dioxide, argon and mixtures thereof.

30. The packaged wine product as recited in claim 29, wherein the volume of the wine in the container is about 187 ml.

31. A packaged wine product comprising:
an oxygen barrier container;
a volume of wine disposed within said oxygen barrier container; and
a volume of one or more gases contained within said oxygen barrier container, the gases having less of a deleterious effect on the wine than air, the oxygen barrier container comprising:
a base;
a receptacle supported on the base; and
a closure,
the base comprising a broad circular lower portion having a predetermined diameter and a lower stem portion extending upward therefrom,
the receptacle being a one-piece, unitary, integral blow molded structure comprising a wall defining an interior containing the volume of wine and an upper stem portion extending downward from the wall, the upper stem portion being mechanically inter-fitted with and welded to the lower stem portion to form a reinforced stem,
the wall having a rim defining an open upper end,
the receptacle having a diameter that varies over its height with its maximum diameter being at a point closer to the bottom than to the top of said container,
the rim including a top surface and a side surface extending downward therefrom, the side surface including a frustoconical portion and an undercut closure retaining surface therebelow,
the closure comprising a removable film seal peelably sealed to the top surface of the rim and removable therefrom without leaving a residue that perceptibly impacts visual, tactile or organoleptic properties of the rim or the predetermined volume of wine when wine is sipped from the receptacle over said rim,
the closure further comprising a reclosable overcap comprising a top wall and a side wall extending therefrom, the side wall having an interior rib defining a reduced inner diameter for interacting with the frustoconical portion of the side surface of the rim to removable retain the closure on the receptacle.

32. The packaged wine product of claim 31, wherein a headspace is filled with a gas which has a deleterious effect on the wine in the container which is less than air.

33. The method of claim 32, wherein the gas is selected from the group consisting of nitrogen, carbon dioxide, argon and mixtures thereof.

34. The method of claim 31, wherein the reinforced stem has a length from about one half inch to about one and one quarter inch.

35. The method of claim 31, wherein the volume of the wine in the container is about 187 ml.

36. A packaged wine product comprising:
a container;
a volume of wine disposed within the container; and
one or more gases contained within the container, the gases having less of a deleterious effect on the wine than air, the container comprising:
a blow molded polyethylene terephthalate receptacle and a closure,
the receptacle being a one-piece, unitary, integral blow molded structure comprising a wall defining an interior containing the volume of wine,
the wall having a rim defining an open upper end,
the receptacle having a diameter that varies over its height with a maximum diameter of the receptacle being at a point closer to the bottom than to the top of the container,
the rim including a top surface and a side surface extending downward therefrom,
the side surface of the rim including a frustoconical portion and an undercut closure retaining surface therebelow,
the closure comprising a removable film seal peelably sealed to the top surface of the rim and removable therefrom without leaving a residue that perceptibly impacts visual, tactile or organoleptic properties of the rim or the predetermined volume of wine when wine is sipped from the receptacle over said rim,
the closure further comprising a reclosable overcap comprising a top wall and a side wall extending therefrom, the side wall having an interior rib defining a reduced inner diameter for interacting with said frustoconical portion of said side surface of the rim to removable retain said closure on said receptacle.

37. The stemware packaged wine product as recited in claim 36, wherein the blow molded polyethylene terephthalate receptacle supported on the base comprises:
a lower truncated spherical base portion which is effective for holding most of the wine in the stemware container; and
a frustoconical portion,
the spherical base portion being above the upper stem and below the frustoconical portion which frustoconical portion extends upwardly from the spherical portion to the rim,
the frustoconical portion defining a headspace above the wine, the headspace having a diameter which is equal to or larger at surface of the wine than an upper portion below the rim.

38. The stemware wine product as recited in claim 37, wherein a headspace is filled with a gas which has a deleterious effect on the wine in the container which is less than air.

39. The stemware wine product of claim 38, wherein the gas is selected from the group consisting of nitrogen, carbon dioxide, argon and mixtures thereof.

40. The method of claim 37, wherein the reinforced stem has a length from about one half inch to about one and one quarter inch.

41. The method of claim 40, wherein the volume of the wine in the container is about 187 ml.

42. A method for packaging a wine product comprising:
adding a volume of wine to an oxygen barrier container;
adding a volume of one or more gases; and
sealing the oxygen barrier container with a removable film seal, and
placing a snapable reclosable overcap over the removable film seal, and
the oxygen barrier container comprising a receptacle comprising blow molded polyethylene terephthalate.

43. The method of claim 42, wherein a headspace is filled with a gas which has a deleterious effect on the wine in the container which is less than air.

44. The method of claim 43, wherein the gas is selected from the group consisting of nitrogen, carbon dioxide, argon and mixtures thereof.

45. The method of claim 44, wherein the volume of the wine in the container is about 187 ml.

46. A method for packaging a wine product comprising:
adding a volume of wine to a stemware container;
adding a volume of one or more gases;
sealing the stemware container with a removable film seal, and
placing a snapable reclosable overcap over the removable film seal, the stemware container comprising:
a base;
a blow molded polyethylene terephthalate receptacle supported on the base; and a closure,
the base comprising a broad circular lower portion having a predetermined diameter and a lower stem portion extending upward therefrom,
the receptacle being a one-piece, unitary, integral blow molded structure comprising a wall defining an interior containing the volume of wine and an upper stem portion extending downward from said wall, the upper stem portion being mechanically inter-fitted with and welded to said lower stem portion to form a reinforced stem,
the wall having a rim defining an open upper end,
the receptacle having a diameter that varies over its height with a maximum diameter of the receptacle being at a point closer to the bottom than to the top of said container such that the center of gravity is below 0.65, the total height of the container when the container is filled with wine,
the rim including a top surface and a side surface extending downward therefrom,
the side surface of the rim including a frustoconical portion and an undercut closure retaining surface therebelow,
the closure comprising a removable film seal peelably sealed to said top surface of the rim and removable therefrom without leaving a residue that perceptibly impacts visual, tactile or organoleptic properties of the rim or the predetermined volume of wine when wine is sipped from the receptacle over said rim,
the closure further comprising a reclosable overcap comprising a top wall and a side wall extending therefrom, the side wall having an interior rib defining a reduced inner diameter for interacting with said frustoconical portion of said side surface of the rim to removable retain said closure on said receptacle.

47. The method of claim 46, wherein a headspace is filled with a gas which has a deleterious effect on the wine in the container which is less than air.

48. The method of claim 47, wherein the gas is selected from the group consisting of nitrogen, carbon dioxide, argon and mixtures thereof.

49. The method of claim 46, wherein the reinforced stem has a length from about one half inch to about one and one quarter inch.

50. The method of claim 46, wherein the volume of the wine in the container is about 187 ml.

51. A packaged wine product comprising:
a container;
a volume of wine disposed within the container; and
one or more gases contained within the container, the gases having less of a deleterious effect on the wine than air, the container comprising:
a blow molded polyethylene terephthalate receptacle and a closure,
the receptacle being a one-piece, unitary, integral blow molded structure comprising a wall defining an interior containing the volume of wine,
the wall having a rim defining an open upper end,
the receptacle having a diameter that varies over its height with a maximum diameter of the receptacle being at a point closer to the bottom than to the top of the container,
the rim including a top surface and a side surface extending downward therefrom,
the side surface of the rim including a frustoconical portion and an undercut closure retaining surface therebelow,
the closure comprising a removable film seal peelably sealed to the top surface of the rim and removable therefrom without leaving a residue that perceptibly impacts visual, tactile or organoleptic properties of the rim or the predetermined volume of wine when wine is sipped from the receptacle over said rim,
the closure further comprising a reclosable overcap comprising a top wall and a side wall extending therefrom, the side wall having an interior rib defining a reduced inner diameter for interacting with said frustoconical portion of said side surface of the rim to removable retain said closure on said receptacle.

52. The packaged wine product of claim 51, wherein the gas is selected from the group of nitrogen, carbon dioxide, argon and mixtures thereof.

53. The packaged wine product as recited in claim 52, wherein the volume of the wine in the container is about 187 ml.
